(19) United States
(12) Patent Application Publication
(10) Pub. No.: US 2023/0050870 A1
(43) Pub. Date: Feb. 16, 2023

(54) SYSTEMS AND METHODS FOR AI META-CONSTELLATION

(71) Applicant: Palantir Technologies Inc., Palo Alto, CA (US)

(72) Inventors: Andrew Elder, Greenwood Village, CO (US); Anand Gupta, Snowmass Village, CO (US); Daniel Cervelli, Wanaka (NZ); Robert Imig, Washington, DC (US); Tess Druckenmiller, Brooklyn, NY (US)

(21) Appl. No.: 17/884,761

(22) Filed: Aug. 10, 2022

Related U.S. Application Data
(60) Provisional application No. 63/232,019, filed on Aug. 11, 2021.

(51) Int. Cl. G06F 9/48; H04L 41/16

(52) U.S. Cl. CPC G06F 9/485; H04L 41/16

(57) ABSTRACT

System and method for device constellation according to certain embodiments. For example, a method for device constellation, the method includes the steps of: receiving a request, the request including a plurality of request parameters; decomposing the request into one or more tasks; selecting one or more edge devices based at least in part on the plurality of request parameters; assigning the one or more tasks to the one or more selected edge devices to cause the one or more selected edge devices to perform the one or more tasks; and receiving one or more task results from the one or more selected edge devices.

### CROSS REFERENCE TO RELATED APPLICATIONS

This application claims priority to U.S. Provisional Application No. 63/232,019, filed Aug. 11, 2021, incorporated by reference herein for all purposes.

### TECHNICAL FIELD

Certain embodiments of the present disclosure are directed to systems and methods for device constellation. More particularly, some embodiments of the present disclosure provide systems and methods for using artificial intelligence (AI) models and other computational models in device constellation.

### BACKGROUND

Artificial intelligence is widely used in analyzing data to facilitate object detection, prediction, decision making, and other uses. For example, AI inference is a process of using AI models to make a prediction. AI inference often needs a large number of computing resources and memory resources.

Edge devices (e.g., devices with sensing and/or computing capability) can be deployed to dispersed locations on earth or in space. Some edge devices may include one or more sensors for collecting sensor data and/or one or more computing resources to process data (e.g., identifying objects). A satellite can include and/or integrate with edge devices. As an example, edge devices can be deployed to various areas to complete certain tasks.

Hence it is desirable to improve the techniques for device constellation.

### SUMMARY

Certain embodiments of the present disclosure are directed to systems and methods for device constellation. More particularly, some embodiments of the present disclosure provide systems and methods for using artificial intelligence models and other computational models in device constellation.

According to some embodiments, a method for device constellation, the method comprising: receiving a request, the request including a plurality of request parameters; decomposing the request into one or more tasks; selecting one or more edge devices based at least in part on the plurality of request parameters; assigning the one or more tasks to the one or more selected edge devices to cause the one or more selected edge devices to perform the one or more tasks; and receiving one or more task results from the one or more selected edge devices; wherein the method is performed using one or more processors.

According to certain embodiments, a method for device constellation, the method includes the steps of: receiving a task assignment, the task assignment including one or more task parameters, the one or more task parameters including a set of collection parameters and a set of monitoring parameters; conducting a task according to the task assignment including the one or more task parameters to collect data; activating one or more models based at least in part on the monitoring parameters; generating a task result by applying the one or more models to the collected data; and transmitting the task result to a computing device; wherein the method is performed using one or more processors.

According to some embodiments, a system for device constellation, the system comprising: one or more memories comprising instructions stored thereon; and one or more processors configured to execute the instructions and perform operations comprising: receiving a request, the request including a plurality of request parameters; decomposing the request into one or more tasks; selecting one or more edge devices based at least in part on the plurality of request parameters; assigning the one or more tasks to the one or more selected edge devices to cause the one or more selected edge devices to perform the one or more tasks; and receiving one or more task results from the one or more selected edge devices.

### BRIEF DESCRIPTION OF THE DRAWINGS

FIG. 1 is a simplified diagram showing a method for device constellations (e.g., meta-constellations) according to certain embodiments of the present disclosure.

FIG. 2 is a simplified diagram showing a method for device constellations (e.g., meta-constellations), for example, by an edge device, according to certain embodiments of the present disclosure.

FIG. 3 is an illustrative AIP architecture (e.g., an AIP and DMP architecture) diagram according to certain embodiments of the present disclosure.

FIG. 4 is an illustrative AIP system according to certain embodiments of the present disclosure.

FIG. 5 is an illustrative AIP diagram according to certain embodiments of the present disclosure.

FIG. 6 is an illustrative device constellation system (e.g., an AI meta-constellation system) according to certain embodiments of the present disclosure.

FIG. 7 is an illustrative device constellation system (e.g., an AI meta-constellation system) according to certain embodiments of the present disclosure.

FIG. 8 is an illustrative device constellation system (e.g., an AI meta-constellation system) according to certain embodiments of the present disclosure.

FIG. 9 is an illustrative device constellation environment according to certain embodiments of the present disclosure.

FIG. 10 is an illustrative AIP system (e.g., model orchestrators, task moderators), for example, used in a device constellation system, according to certain embodiments of the present disclosure.

FIG. 11 is an illustrative constellation environment according to certain embodiments of the present disclosure.

FIG. 12 shows an example device constellation system according to certain embodiments of the present disclosure.

FIG. 13 is an example device constellation environment (e.g., an AI meta-constellation environment) according to certain embodiments of the present application.

FIG. 14 is an example device constellation environment (e.g., an AI meta-constellation environment) according to certain embodiments of the present application.

FIG. 15 is a simplified diagram showing a computing system for implementing a system for device constellation according to one embodiment of the present disclosure.

### DETAILED DESCRIPTION

Unless otherwise indicated, all numbers expressing feature sizes, amounts, and physical properties used in the specification and claims are to be understood as being modified in all instances by the term “about” according to some embodiments. Accordingly, for example, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein according to certain embodiments. However, some embodiments may require certain steps and/or certain orders between certain steps, as may be explicitly described herein and/or as may be understood from the nature of the steps themselves (e.g., the performance of some steps may depend on the outcome of a previous step). Additionally, for example, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input according to some embodiments. As an example, predicting an outcome based on a particular piece of information may additionally, or alternatively, base the same determination on another piece of information. As used herein, for example, the term “receive” or “receiving” means obtaining from a data repository (e.g., database), from another system or service, from another software, or from another software component in a same software. In certain embodiments, the term “access” or “accessing” means retrieving data or information, and/or generating data or information.

According to some embodiments, a device constellation system (e.g., an AI meta-constellation system) uses AI Inference Platform (AIP) for one or more constellations of edge devices. For example, the device constellation system combines one or more heterogenous satellite constellations and/or leveraging artificial intelligence (AI) to give one or more users one or more actionable insights from one or more overhead sensors. In some examples, the AI device constellation system (e.g., meta-constellation system) combines one or more edge devices (e.g., a satellite with one or more sensors) and/or leveraging AI to give one or more users one or more actionable insights. In certain examples, an edge device is a physical device including one or more sensors, an AIP, and/or one or more model(s). As used herein, a model, referred to as a computing model, includes a model to process data. A model includes, for example, an AI model, a machine learning (ML) model, a deep learning (DL) model, an image processing model, an algorithm, a rule, other computing models, and/or a combination thereof.

According to certain embodiments, AI Inference Platform (AIP) orchestrates between the input sensor data and output feeds. As an example, AIP is a model orchestrator, also referred to as a task orchestrator. For example, the input and/or output (e.g., “left” side, “right” side) of AIP are utilizing open standard formats. As an example, AIP takes care of the decoding of the input data, orchestration between processors and artificial intelligence (AI) models, and then packages up the results into an open output format for downstream consumers.

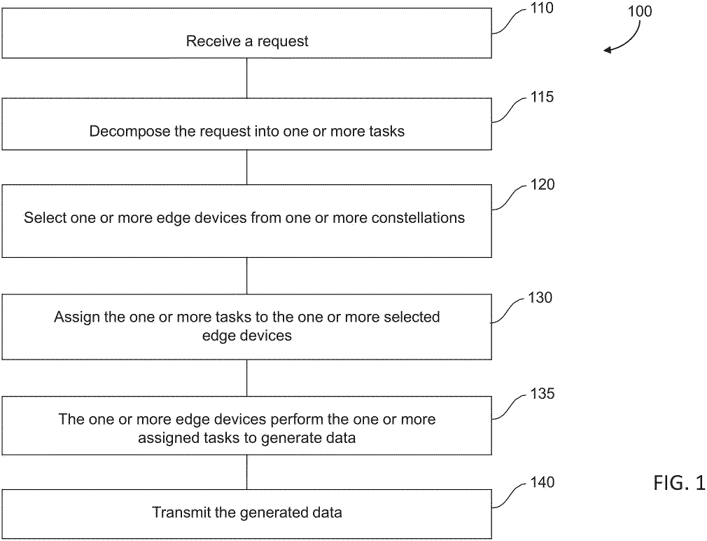

FIG. 1 is a simplified diagram showing a method for device constellations (e.g., meta-constellations) according to certain embodiments of the present disclosure. This diagram is merely an example. One of ordinary skill in the art would recognize many variations, alternatives, and modifications. The method 100 for device constellations includes processes 110, 115, 120, 130, 135, and 140. Although the above has been shown using a selected group of processes for the method 100 for device constellations, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to some embodiments, at the process 110, a device constellation system is configured to receive a request. In certain examples, the request is submitted by and/or received from a user. In some examples, the request is automatically generated by a device (e.g., a control device at a base station, an edge device, a smart phone, etc.).

According to certain embodiments, at the process 115, the system is configured to decompose the request into one or more tasks. In some examples, the request is decomposed into one or more tasks based on one or more factors (e.g., request parameters, collection parameters, monitoring parameters, etc.). In certain examples, the factors include one or more of a location, a time window, a frequency, an objective (e.g., locating an object), other factors, and/or a combination thereof. For example, the request is to monitor a space area for two weeks.

According to some embodiments, at the process 120, the system is configured to select one or more edge devices (e.g., a plurality of edge devices) from one or more constellations (e.g., a plurality of constellations). In some examples, each of the one or more constellations is owned by and/or operated by an entity (e.g., a government organization, a company, an industry organization, etc.). As an example, two constellations are owned by and/or operated by two different entities. In certain examples, a meta-constellation is formed including one or more edge devices from one or more constellations owned by and/or operated by various entities. For example, at the process 120, the system is configured to select multiple edge devices from a plurality of constellations, and each constellation of the plurality of constellations is owned by and/or operated by an entity (e.g., a government organization, a company, an industry organization, etc.). As an example, some selected multiple edge devices belong to a constellation owned by and/or operated by an entity, and other selected multiple edge devices belong to a different constellation owned by and/or operated by different entity. In some examples, the system is configured to select one or more edge devices based on capability, eligibility, and/or availability of the corresponding edge device. For example, an edge device is a satellite that includes one or more sensors, where the one or more sensors are also referred to as orbit sensors. As an example, an edge device includes one or more sensors in the space. For example, an edge device is selected based on a viewing angle of an imaging sensor on the edge device. As an example, an edge device is selected based on its location in the water. In some examples, the system selects the edge device based upon one or more sensors and/or one or more models. For example, an edge device is selected to use a specific model to process data.

According to certain embodiments, at the process 130, the system is configured to assign the one or more tasks to the one or more selected edge devices. According to some embodiments, at the process 135, the one or more selected edge devices are configured to perform the one or more assigned tasks to generate data. In some examples, the one or more edge devices are configured to collect data during the performance of the one or more assigned tasks. In certain examples, the one or more edge devices are configured to process the collected data. In some examples, the edge device is configured to generate one or more insights by processing the data collected by one or more sensors on the edge device and/or data collected by one or more sensors on one or more other edge devices. In certain examples, the generated data by the one or more selected edge devices includes the collected data, the processed data, the one or more insights, and/or a combination thereof. As an example, an edge device is assigned with a task of monitoring a space area for two weeks and is configured to filter the monitoring data (e.g., removing certain data). For example, an edge device is assigned with a task of detecting wildfire and is configured to process data collected from various sensors on the edge device and transmit an insight of whether wildfire is detected.

According to some embodiments, the system is configured to request a source edge device to transmit data (e.g., collected data and/or processed data) to a destination edge device. In some examples, the destination edge device is configured to process data from the source edge device. In certain examples, the system is configured to move more complex processing to the one or more edge devices. In certain examples, two or more edge devices are configured to transmit data to a selected edge device for data processing.

According to certain embodiments, each of the one or more selected edge devices includes AI Inference Platform (AIP) that provides interfaces to one or more sub-systems (e.g., one or more sensors) and/or one or more models (e.g., one or more micro-models) and/or perform certain data processing. For example, the one or more selected edge devices are configured to perform the one or more assigned tasks by using at least one or more AIPs.

According to some embodiments, at the process 140, the one or more edge devices are configured to transmit the generated data (e.g., collected data, processed data, one or more insights, etc.). In some examples, the one or more edge devices are configured to transmit the generated data to a device (e.g., a control device at a base station, a smart phone, etc.).

According to certain embodiments, the device constellation system receives one or more additional requests and generates a plurality of request queues for the request and the one or more additional requests. In some embodiments, the plurality of request queues include a first request queue for data collection and a second queue for data processing. In certain embodiments, the system is configured to decompose the request and the one or more additional requests into a plurality of sub-requests; and store the plurality of sub-requests into one of the plurality of request queues. In certain embodiments, at least one task of the one or more tasks is generated based on the plurality of sub-requests.

As discussed above and further emphasized here, FIG. 1 is merely an example. One of ordinary skill in the art would recognize many variations, alternatives, and modifications. As an example, an edge device is an aircraft, a submarine, and/or a vehicle. As an example, an edge device includes one or more sensors in the air, in the space, under the sea, in the water, on the land, and/or at other locations.

According certain embodiments, device constellation systems (e.g., meta-constellation systems) and/or methods harness the power of growing constellations (e.g., satellite constellations), and/or deploy AI into space to provide insights to decision-makers on Earth. In some examples, device constellation systems (e.g., meta-constellation systems) and/or methods orchestrate and/or optimize hundreds of orbital sensors and AI models. In certain examples, device constellation systems (e.g., meta-constellation systems) and/or methods allow users to ask one or more questions (e.g., one or more time-sensitive questions) across entire planet. In some examples, some example questions include, for example, 1) where the indicators of wildfires are; 2) how are climate changes affecting crop productivity; and/or 3) when are naval fleets conducting operations.

According to some embodiments, device constellation systems (e.g., meta-constellation systems) and/or methods are configured to push edge AI technology to a new frontier. For example, device constellation systems (e.g., meta-constellation systems) and/or methods include a transformation in various fields, such as the fields of one of the hardest maritime issues - submarines. As an example, fast and stealthy, advanced submarines present threats to some countries. For example, to protect strategic interests, some countries and/or allied forces need to track every submarine’s deployment around the world. As an example, at the forefront are anti-submarine warfare officers. In response to allied monitoring requests, in certain examples, device constellation systems (e.g., meta-constellation systems) and/or methods are configured to dynamically determine which orbiting sensors are available. In some examples, integrated through device constellation systems (e.g., meta-constellation systems) and/or methods, the one or more constellations collaboratively schedule coverage over one or more ports (e.g., each port of the one or more ports).

According to certain embodiments, the AIP assigns tailored one or more models (e.g., micro-models, AI models) to each satellite. As an example, running onboard the satellites, the one or more models automatically couple to submarines and stream one or more insights directly to users. For example, with the mission planned, the AIP associated with or integrated into the device constellation systems (e.g., meta-constellation systems) automatically reconfigures each of the satellites, for example, pushing the right micro-models into orbit. For example, as a software payload onboard, the AIP connects complex satellite subsystems to models (e.g., micro-models) and/or integrates new AI with the hardware. In some examples, as a satellite orbits, the AIP is configured to hot swap the right micro-models in the satellite and/or rapidly reconfigure the satellite.

In certain examples, the one or more models are configured to process one or more images or videos (e.g., imagery), detect the submarines, geolocate them, and/or determine any movements since the last collection pass, for example, all in under a second. In some examples, when the one or more models detect a submarine movement, the insight of a detection of submarine movement is directly downlinked to certain countries and/or allied forces as the satellite passes overhead. As an example, anti-submarine warfare officers are notified in just minutes.

According to some embodiments, device constellation systems (e.g., meta-constellation systems) and/or methods bring hundreds of satellites to bear on some hard problems (e.g., some hardest problems), for example, anti-submarine warfare officers deploying AI into orbit to find submarines, and/or first-responders leveraging AI to spot wildfire signs. In some examples, device constellation systems (e.g., meta-constellation systems) and/or methods are there to empower users.

According to certain embodiments, as the data generated by orbital sensors continues to increase in volume and complexity, the ability to run AI onboard satellites or satellite sensors is important (e.g., critical). In some examples, deploying AI at the edge in space allows for efficient and consistent processing of noisy, high-scale GEOINT and radio frequency (RF) data, reducing the amount of data that needs to be stored and transmitted and/or enabling low-latency decision-making for near real-time actions, such as tasking a sensor to perform a job. In certain examples, AIP deployed directly onboard spacecraft accelerates model deployment and improvement, improves data processing, and/or reduces the need to downlink data before taking action.

According to some embodiments, one or more solutions are described. For example, AIP is integrated into or associated with a system (e.g., a data integration system). As an example, AI Inference Platform (AIP) is an AI orchestration and fusion platform designed to run on cloud infrastructure, on-premise GPU servers, and/or Size, Weight, and Power (SWaP) optimized hardware for embedding into satellites. In some examples, AIP connects data to one or more algorithms, runs those algorithms in real-time, and/or produces one or more outputs that can either be used onboard by other systems or transmitted to ground. As an example, when coupled with a development and management platform (DMP), AIP allows one or more DMP-managed AI models to be seamlessly deployed from cloud to space. For example, insights from the one or more edge-deployed models can flow back into the DMP, advancing the retraining and Continuous Integration / Continuous Deployment (CI/CD) of one or more models across satellite constellations.

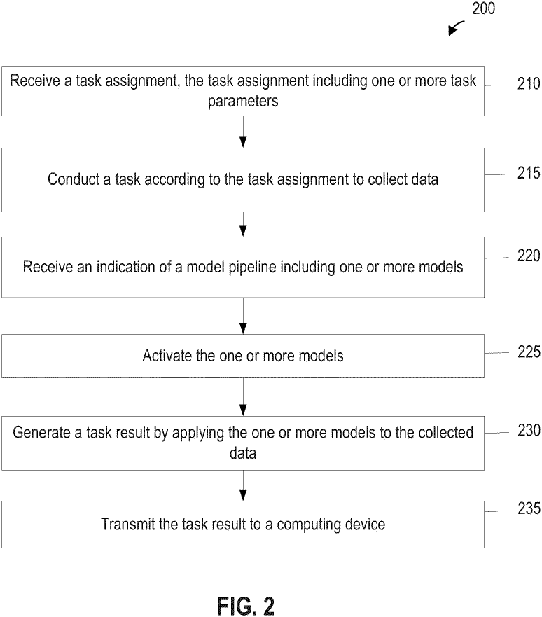

According to certain embodiments, AIP and DMP Architecture diagram is described in FIG. 2. FIG. 2 is merely an example. One of ordinary skill in the art would recognize many variations, alternatives, and modifications.

According to some embodiments, AIP is a highly configurable and modular infrastructure for dynamic model orchestration. For example, AIP consumes media streams from a variety of sensors (e.g., SAR data, EO/IR imagery, RF data, and/or FMV feeds) and applies one or more optional AI processing (e.g., containerized micro models including all necessary dependencies to run, such as libraries and drivers) to produce AI outputs. As an example, using diverse sensor inputs, AIP provides users at ground stations with a configuration interface for interacting with sensor data and managing one or more models and their connection to data through one or more open APIs. In some examples, AIP handles a variety of input formats, such as real-time streaming RTP/RTSP, NITF, GeoTIFF, and/or, as FMV comes to space, MPEG-TS over UDP or from a file. In certain examples, as a configurable and interoperable system, AIP supports outputs in a variety of standard formats (e.g., open standard formats), such as XML, CoT, and GeoJSON, which enable sending data and insights downstream to other subsystems with little to no integration work required.

According to certain embodiments, AIP includes one or more tools to streamline and automate complex data engineering tasks. In some examples, AIP includes one or more Computer Vision (CV) Models. For example, AIP provides an intuitive interface and one or more tools for users to iterate on one or more CV models in support of objectives, such as space situational awareness, vessel/vehicle tracking, facility activity analysis, land use or construction, and/or others. In certain examples, AIP includes one or more RF Processing. For example, AIP supports one or more algorithms for automating the analysis of signals by signature. As an example, AIP supports pre-processing of the data, such as filtering incoming signals to reduce noise and/or splitting up waves into parts, for example, via Fourier transforms.

In some examples, AIP includes one or more image processing. For example, rendering EO or SAR collects into images (e.g., useful and/or useful, high-quality images) for analysis by humans or algorithms, all of which can be applied in AIP. As an example, performing the one or more image corrections at the sensor is an enabler for one or more fusion workflows onboard the spacecraft. Additionally, for example, as many AI models are trained on corrected data in machine learning environments, they require various corrected imagery at the point of collection. As an example, AIP includes orthorectification, which is for correcting optical distortions from sensor angles. For example, AIP includes pan-sharpening for creating a color image (e.g., high-resolution color image) out of one or more panchromatic and multispectral images. As an example, AIP includes georegistration for correcting geospatial information on the image to generate more precise coordinates. For example, AIP includes image formation for turning SAR data into images. As an example, AIP including tiling for breaking a large image into one or more tiles (e.g., consumable chunks of pixels), for example, that a CV model can handle, and then handling the merging of detections and AI insights across one or more tiles back into a single view.

According to some embodiments, AIP includes adaptive runtime configuration. For example, AI pipelines are tailored to run one or more operation-specific and small, modular models (“micro models”) as processors in parallel or with set dependencies on one or more other processors. As an example, AIP allows for switching out one or more algorithms as needed and optimizing on factors including quality of output, speed, and/or bandwidth. In some examples, importantly (e.g., critically), one or more micro models can be hot swapped in real-time without breaking model outputs and/or requiring massive software baseline changes.

According to certain embodiments, AIP includes a lightweight and/or modular interface that can conduct one or more compute processes (e.g., critical compute processes) in one or more remote or resource-constrained environments. For example, AIP runs on an organization’s specialized satellite computing hardware and/or other, low-SWaP form-factors, such as the NVIDIA Jetson product suite. As an example, this allows organizations to AI-compress data into “insight-first” streams to the Earth, optimizing scarce bandwidth to ground stations. In certain examples, by running models on a minute form factor, AIP makes smart and/or autonomous sensor work possible. In some examples, deploying AIP at the point of use enables one or more AI detections (e.g., optimum quality AI detections) derived from the one or more sensor inputs (e.g., high-quality highest sensor inputs, highest quality sensor inputs).

According to some embodiments, AIP is applied to one or more use cases. In some examples, AIP is used for efficient analysis in space. For example, with AIP deployed onboard spacecraft, one or more sophisticated AI models are rapidly integrated and swapped out as objectives evolve, feedback is received, and/or one or models are retrained. As an example, with low-latency decision-making possible at the edge, AIP reduces or removes the need to downlink before the next action.

In certain examples, AIP is used for tasking. As an example, satellite companies integrate their tasking and/or catalog API into a system (e.g., a data integration system), allowing users to task a constellation. For example, with AIP capturing one or more key parameters of customer requests, such as geographic area, time period, and/or the desired objects, a new data asset (e.g., a powerful new data asset) is generated that can be combined with the corresponding sensor data for advanced modeling and one or more new opportunities.

In some examples, AIP is used for sensor fusion. For example, AIP supports one or more multi-sensor models to fuse data across one or more diverse payloads. As an example, if a customer uses RF and EO collection, they can field one or more AI models with DMP, combining both modalities to achieve higher fidelity in detecting one or more entities of interest (e.g., military equipment). For example, the one or more fusion models are deployed to AIP and run onboard spacecraft.

In certain examples, AIP is used for command and control. As an example, AIP enables customers to achieve a sensor-to-shooter workflow. For example, after sending a tasking from a ground station to a satellite with AIP, the software orchestrates the imaging, localization, and/or AI detection of a target, ultimately sending that target directly to terrestrial shooters, such as strike aircraft over secure protocols (e.g., JREAP-C, a U.S. military standard for transmitting tactical data messages over one or more long-distance networks, such as one or more satellite links).

FIG. 2 is a simplified diagram showing a method for device constellations (e.g., meta-constellations), for example, by an edge device, according to certain embodiments of the present disclosure. This diagram is merely an example. One of ordinary skill in the art would recognize many variations, alternatives, and modifications. The method 200 for device constellations includes processes 210, 215, 220, 225, 230, and 235. Although the above has been shown using a selected group of processes for the method 200 for device constellations, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to some embodiments, at the process 210, a device constellation system and/or an edge device receives a task assignment, where the task assignment includes one or more task parameters, for example, a part or all of request parameters of a request with which the task assignment is associated. In certain embodiments, the one or more task parameters include a set of collection parameters and a set of monitoring parameters. In some embodiments, the edge device receives via a task orchestrator (e.g., an AIP), where the task orchestrator includes an indication of a model pipeline, and where the model pipeline includes the one or more models.

According to certain embodiments, at the process 215, the edge device conducts a task according to the task assignment to collect data. In some embodiments, at the process 220, the edge device receives an indication of a model pipeline including one or more models. In certain embodiments, at the process 225, the edge device activates the one or more models. In some embodiments, at the process 230, the edge device generates a task result by applying the one or more models to the collected data. In certain embodiments, at the process 235, the edge device transmits the task result to a computing device (e.g., a controlling device).

According to some embodiments, the edge device activates one or more models by at least: receiving at least one model of the one or more models; and activating the at least one received model. In certain embodiments, the task result is transmitted via the task orchestrator (e.g., the AIP).

According to some embodiments, AIP orchestrates between the input sensor data and output feeds. For example, the “right” sides of AIP are utilizing open standard formats. As an example, AIP takes care of the decoding of the input data, orchestration between processors and artificial intelligence (AI) models, and then packages up the results into an open output format for downstream consumers.

According to certain embodiments, AIP is a modular approach (e.g., a completely modular approach) to sensor processing. For example, AIP takes in arbitrary sensor feeds (e.g., video) and then decodes the incoming stream into consumable messages, so that one or more 3rd party processors can interact with the sensor data (e.g., in a very simple way). As an example, an incoming real-time video stream with binary metadata is decoded into a simple frame (e.g., a picture) and corresponding metadata into a protobuf over gRPC message to the respective processors.

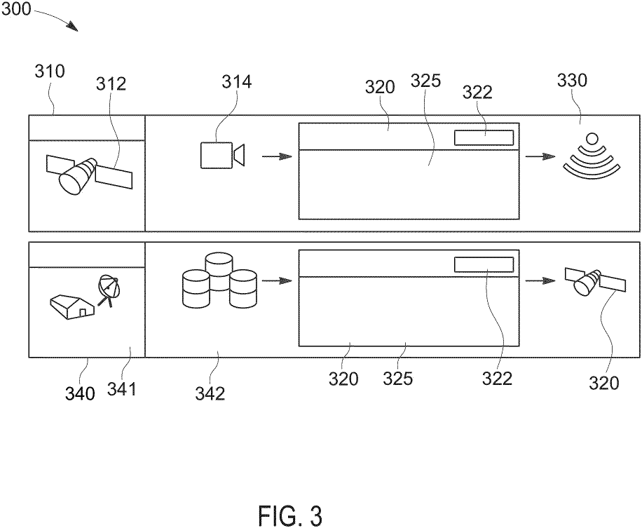

FIG. 3 is an illustrative AIP architecture 300 (e.g., an AIP and DMP architecture) diagram according to certain embodiments of the present disclosure. FIG. 3 is merely an example. One of ordinary skill in the art would recognize many variations, alternatives, and modifications.

According to some embodiments, the AIP architecture 300 (e.g., an AIP system) includes an AIP system 310 and a DMP system 340. In certain embodiments, the AIP system 310 includes an edge device 312, sensor data 314 (e.g., real-time sensor data), an AIP 320 on a runtime service running one or more models 325 via one or more interfaces 322, and model outputs 330. In some embodiments, the AIP architecture 300 includes a device 341 (e.g., a device at a ground station), one or more data repository 342, an AIP 320 (e.g., a model orchestrator, a task orchestrator) running on a development service for developing, testing, and deploying one or more models 325 via the one or more interfaces 322, and generate the AIP 320 with one or more models 325.

In certain embodiments, AIP 320 is a highly configurable and modular infrastructure for dynamic model orchestration. For example, AIP consumes media streams from a variety of sensors (e.g., SAR (synthetic aperture radar) data, EO/IR (electro-optical/infrared) imagery, RF data, and/or FMV feeds) and applies one or more optional AI processing (e.g., containerized micro models including all necessary dependencies to run, such as libraries and drivers) to produce AI outputs. As an example, using diverse sensor inputs, AIP provides users at ground stations with a configuration interface for interacting with sensor data and managing one or more models and their connection to data through one or more open APIs. In some examples, AIP handles a variety of input formats, such as real-time streaming RTP/RTSP (Real-time Transport Protocol/ Real Time Streaming Protocol), NITF (National Imagery Transmission Format Standard), GeoTIFF (Geostationary Earth Orbit Tagged Image File Format), and/or, as FMV comes to space, MPEG-TS (MPEG transport stream) over UDP or from a file. In certain examples, as a configurable and interoperable system, AIP supports outputs in a variety of standard formats (e.g., open standard formats), such as XML, CoT, and GeoJSON, which enable sending data and insights downstream to other subsystems with little to no integration work required.

According to certain embodiments, AIP includes one or more tools to streamline and automate complex data engineering tasks. In some examples, AIP includes one or more Computer Vision (CV) Models. For example, AIP provides an intuitive interface and one or more tools for users to iterate on one or more CV models in support of objectives, such as space situational awareness, vessel/vehicle tracking, facility activity analysis, land use or construction, and/or others. In certain examples, AIP includes one or more RF Processing. For example, AIP supports one or more algorithms for automating the analysis of signals by signature. As an example, AIP supports pre-processing of the data, such as filtering incoming signals to reduce noise and/or splitting up waves into parts, for example, via Fourier transforms.

In some examples, AIP includes one or more image processing. For example, rendering EO or SAR collects into images (e.g., useful and/or useful, high-quality images) for analysis by humans or algorithms, all of which can be applied in AIP. As an example, performing the one or more image corrections at the sensor is an enabler for one or more fusion workflows onboard the spacecraft. Additionally, for example, as many AI models are trained on corrected data in machine learning environments, they require various corrected imagery at the point of collection. As an example, AIP includes an interface to one or more orthorectification models, which are for correcting optical distortions from sensor angles. For example, AIP includes an interface to one or more pan-sharpening models for creating a color image (e.g., high-resolution color image) out of one or more panchromatic and multispectral images. As an example, AIP includes an interface to one or more georegistration models for correcting geospatial information on the image to generate more precise coordinates. For example, AIP includes an interface to one or more image formation models for turning SAR data into images. As an example, AIP includes an interface to one or more tiling models for breaking a large image into one or more tiles (e.g., consumable chunks of pixels), for example, that a CV model can handle, and then handling the merging of detections and AI insights across one or more tiles back into a single view.

According to some embodiments, AIP includes adaptive runtime configuration. For example, AI pipelines are tailored to run one or more operation-specific and small, modular models (“micro models”) as processors in parallel or with set dependencies on one or more other processors. As an example, AIP allows for switching out one or more algorithms as needed and optimizing on factors including quality of output, speed, and/or bandwidth. In some examples, importantly (e.g., critically), one or more micro models can be hot swapped in real-time without breaking model outputs and/or requiring massive software baseline changes.

According to certain embodiments, AIP includes a lightweight and/or modular interface that can conduct one or more compute processes (e.g., critical compute processes) in one or more remote or resource-constrained environments. For example, AIP runs on an organization’s specialized satellite computing hardware and/or other, low-SWaP form-factors. As an example, this allows organizations to AI-compress data into “insight-first” streams to the earth, optimizing scarce bandwidth to ground stations (e.g., a computing device at a ground station). In certain examples, by running models on a minute form factor, AIP makes smart and/or autonomous sensor work possible. In some examples, deploying AIP at the point of use enables one or more AI detections (e.g., optimum quality AI detections) derived from the one or more sensor inputs (e.g., high-quality highest sensor inputs, highest quality sensor inputs).

According to some embodiments, AIP is applied to one or more use cases. In some examples, AIP is used for efficiently analysis in space. For example, with AIP deployed onboard spacecraft, one or more sophisticated AI models are rapidly integrated and swapped out as objectives evolve, feedback is received, and/or one or models are retrained. As an example, with low-latency decision-making possible at the edge, AIP reduces or removes the need to downlink before the next action.

In certain embodiments, AIP is used for tasking. As an example, satellite companies integrate their tasking and/or catalog API into a system (e.g., a data integration system), allowing users to task a constellation. For example, with AIP capturing one or more key parameters of customer requests, such as geographic area, time period, and/or the desired objects, a new data asset (e.g., a powerful new data asset) is generated that can be combined with the corresponding sensor data for advanced modeling and one or more new opportunities.

In some embodiments, AIP is used for sensor correlation. For example, AIP supports one or more multi-sensor models to fuse data across one or more diverse payloads. As an example, if a customer uses RF and EO collection, they can field one or more AI models with DMP, combining both modalities to achieve higher fidelity in detecting one or more entities of interest (e.g., military equipment). For example, the one or more fusion models are deployed to AIP and run onboard spacecraft.

In certain embodiments, AIP is used for command and control. As an example, AIP enables customers to achieve a sensor-to-actor workflow (e.g., a sensor-to-shooter workflow). For example, after sending a tasking from a ground station to a satellite with AIP, the software orchestrates the imaging, localization, and/or AI detection of a target, ultimately sending that target directly to terrestrial shooters, such as strike aircraft over secure protocols (e.g., JREAP-C, a U.S. military standard for transmitting tactical data messages over one or more long-distance networks, such as one or more satellite links).

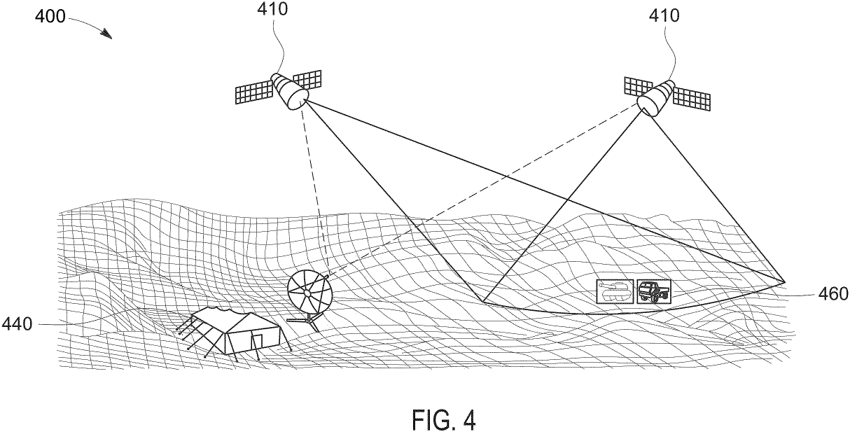

FIG. 4 is an illustrative AIP system 400 according to certain embodiments of the present disclosure. FIG. 4 is merely an example. One of ordinary skill in the art would recognize many variations, alternatives, and modifications. In some embodiments, the AIP system 400 includes one or more edge devices 410 and a DMP 440. In certain embodiments, the edge devices 410 run one or more AIPs onboard. In some examples, the edge devices 410 with the AIPs to conduct real-time AI/ML for multi-sensor correlation and detection of objects 460. In certain embodiments, the DMP 440 is configured to develop, evaluate and deploy AlPs with interfaced one or more models to the edge device 410. In some embodiments, the edge devices 410 can be deployed to one or more satellites.

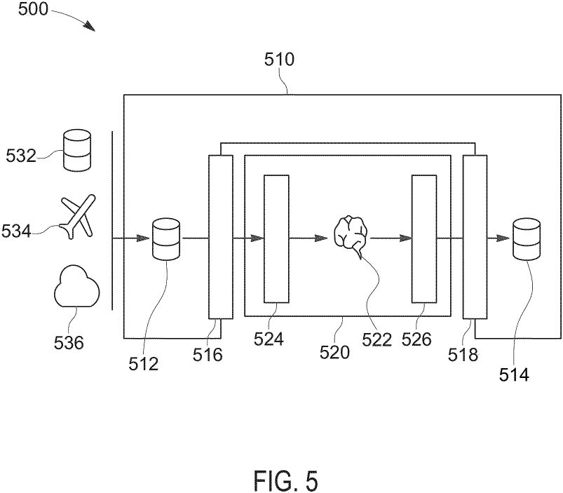

FIG. 5 is an illustrative AIP diagram according to certain embodiments of the present disclosure. FIG. 5 is merely an example. One of ordinary skill in the art would recognize many variations, alternatives, and modifications. According to some embodiments, AIP is a modular approach (e.g., a completely modular approach) to sensor processing. For example, AIP takes in sensor feeds (e.g., arbitrary sensor feeds, video) and then decodes the incoming sensor data (e.g., video stream) into consumable messages, so that one or more models (e.g., one or more 3rd party processing models) can interact with the sensor data (e.g., in a very simple way). As an example, an incoming real-time video stream with binary metadata is decoded into a simple frame (e.g., a picture) and corresponding metadata into a data package defined in an interface definition language (e.g., a platform-neutral data format, a language-neutral data format, protocol buffers (protobuf), protobuf over remote procedure call message) sent to the respective processors (e.g., computational models). As used herein, a processor refers to a computational model. In some embodiments, a processor refers to a computational model in execution.

In certain embodiments, AIP is also built in a way where it is light-weight (e.g., extremely light-weight) so AIP can be scaled up and/or down. For example, this allows a computing system using the AIP to deploy the same software on large servers (e.g., GPU (graphics processing units)) in a data center and/or deploy the same software to a small chip on a satellite. As an example, AIP is deployed in the cloud for video processing (e.g., large-scale video processing).

In some embodiments, AIP is deployed at the edge onto physical devices. For example, AIP is deployed onto one or more aircrafts (e.g., one or more unmanned aircrafts and/or one or more manned aircrafts), one or more vehicles, one or more boats, one or more processing plants. As an example, AIP is deployed to one or more satellites.

According to certain embodiments, the AIP system 500, for example, an AIP development and management platform (DMP) 500, includes an AIP 510, for example, running on an orchestrator service. In some embodiments, the AIP 510 includes an indication of a model pipeline 520 including one or more computational models, for example, running on a model service. In some embodiments, the AIP 510 is configured to process data into processed data (e.g., AI-ready data), to be stored and accessed from a data repository 512. In certain embodiments, the AIP 510 includes a first data repository 512 to receive and store input data (e.g., AI-ready data), a second repository 514 to receive and store model output data, a first API (e.g., data API) to receive sensor data, and a second API (e.g., inference API) to receive model output. In certain embodiments, the AIP 510 is configured to select one or more models based at least in part on one or more data characteristics, one or more processing characteristics and/or one or more user feedback. In certain examples, the processing characteristic may include a video frame extraction, an imaging processing, an object recognition, a decoding, an encoding, and other data processing characteristic. In some examples, the data characteristic may include an input data type (e.g., a sensor data type), an input data format (e.g., sensor data format), an input data volume, an input data range, an output data type, an output data format, and/or the like.

In some embodiments, the DMP 500 is configured to select two or more models to run in parallel in the model pipeline 520, where a first model’s input has a first data format and a second model’s input has a second data format. In certain examples, the first data format is the same as the second data format. In some examples, the first data format is different from the second data format. In certain embodiments, the DMP 500 is configured to select two or more models to run in sequence in the model pipeline 520, where a first model’s output is an input to a second model. In some embodiments, the DMP 500 is configured to select two or more models running in parallel, where the two or more models generate respective model outputs provided to a third model. In certain embodiments, the third model has a software interface to receive results from the two or more models. In some embodiments, the model pipeline 520 includes an input vector 524 to receive data from the data API 516, one or more models 522, and an output vector 526 to output data to the inference API 518.

According to certain embodiments, the AIP system 500 is configured to receive historical data 532, sensor data 534 (e.g., real-time sensor data), and/or data from data repository 536 (e.g., security data repository) to select, develop, update, test, and/or evaluate the AIP 510 and/or the model pipeline 520. In some embodiments, the AIP 510 is configured to process the historical data 532, sensor data 534, and/or data from data repository 536 to generate AI-ready data, for example, data ready to be used with data API 516.

According to some embodiments, providing artificial intelligence (AI) and machine learning (ML) models with a steady stream of data is important (e.g., critical) to one or more models delivering one or more performant results. For example, the one or more models that can speedily consume and process data live “on the fly” allow any AI-derived insights to be used immediately, expediting the delivery of outcomes. In certain examples, in some settings, such as remote, air, space, edge, and/or other disconnected environments, it is important to quickly, consistently, and/or constantly transfer streaming data to the one or more models. For example, the streaming data include high-scale and/or noisy sensor data and/or full motion video (FMV). In some examples, this task is implemented by a system that is: (1) agnostic to one or more model frameworks; (2) modular—to allow for different configurations depending on the desired use case; and/or (3) lightweight and/or deployable where the data is being collected—so that the one or more models are developed and re-trained even when networks are unavailable. For example, the AIP accelerates model improvement and the efficacy of AI so one or more organizations can devote their resources to one or more other efforts, such as researching, developing, training, and/or refining one or more models.

According to some embodiments, one or more solutions are described. For example, AIP is integrated into or operated with a system (e.g., a data integration system). As an example, an AI Inference Platform (AIP) manages and orchestrates the dynamic consumption of data by models. For example, this portable solution helps provide useful AI outputs wherever fielded for live model development and re-training. As an example, the AIP serves as an AI orchestration engine for connecting data to one or more models and/or is responsible for running one or more models in real-time. For example, the AIP is used in conjunction with the AI development and management platform and/or the AI operations platform.

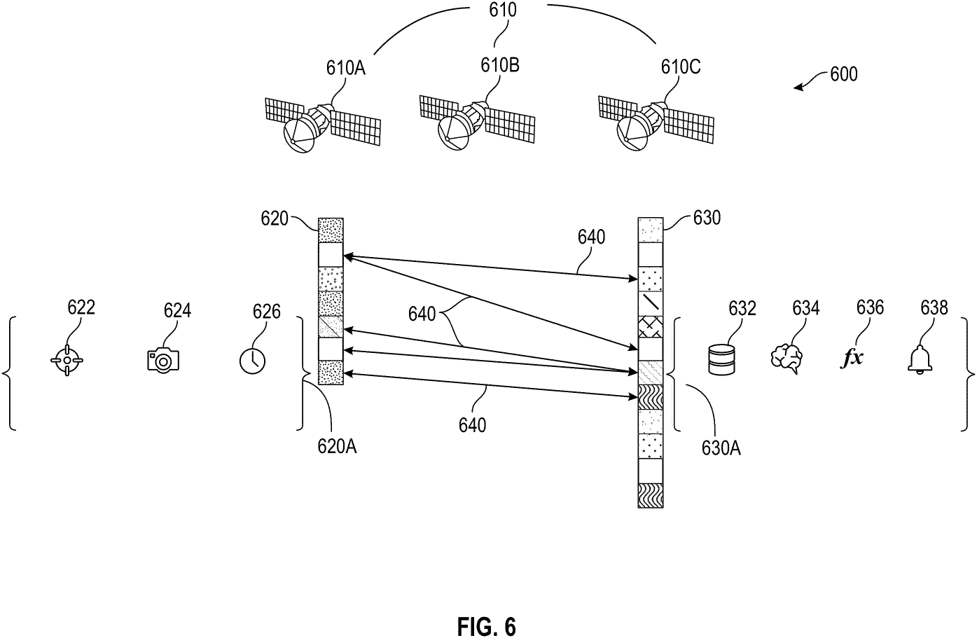

FIG. 6 is an illustrative device constellation system 600 (e.g., an AI meta-constellation system) according to certain embodiments of the present disclosure. FIG. 6 is merely an example. One of ordinary skill in the art would recognize many variations, alternatives, and modifications. In certain embodiments, the device constellation system 600 includes one or more edge devices 610, a collection request queue 620, and a monitor request queue 630 (e.g., an algorithm request queue). In some embodiments, FIG. 6 shows two or more queues (e.g., dual queues) used in a device constellation system, for example, a collection request queue (e.g., a global collection queue) and an algorithm request queue (e.g., an AI monitoring request queue).

According to certain embodiments, the one or more edge devices 610 includes a first edge device 610A (e.g., a computing device disposed on or integrated with a satellite, a satellite, a vessel, etc.), a second edge device 610B (e.g., a computing device disposed on or integrated with a satellite, a satellite, a vessel, etc.), and a third edge device 610C (e.g., a computing device disposed on or integrated with a satellite, a satellite, a vessel, etc.). In some embodiments, one or more of the edge devices 610 includes an AIP, for example, for receiving one or more requests and/or transmitting data. In certain embodiments, each edge device 610 includes an AIP, for example, for receiving one or more requests and/or transmitting data. In some embodiments, the device constellation system 600 includes two or more request queues storing one or more requests to the one or more edge devices 610. In certain embodiments, the queues are stored or accessible via one or more edge devices 610. In some embodiments, the collection request queue 620 includes one or more collection requests 620A for sensor data collection. In certain embodiments, the monitor request queue 630 includes one or more monitoring requests 630A for monitoring and processing requests.

According to some embodiments, a collection request 620A includes data for one or more collection parameters including, for example, one or more location and/or field-of-view parameters 622, one or more sensor parameters 624, one or more timing parameters 626 (e.g., pass timing and/or revisit), and/or the like. In certain embodiments, the one or more location parameters 622 include one or more of a geographic coordinate parameter, a latitude parameter, a longitudinal parameter, an altitude parameter, a geohash parameter, a GPS (global-positioning-system) parameter, and/or the like. In some embodiments, the one or more field-of-view parameters 622 include one or more location parameters and one or more of an angle, an angle range, an area, and/or the like. In certain embodiments, the one or more sensor parameters 624 include a type of sensor, a feature of sensor, a configuration of sensor, a sensing range, a sensing angle, a sensing time, and/or the like. In some examples, the sensor is an image sensor, and the sensor parameters include a zooming parameter, a resolution parameter, a frame rate parameter, a gain parameter, a binning parameter, an image format parameter, and/or the like. In certain examples, the sensor includes an acoustic sensor, a transducer, an ultrasonic sensor, an infrared sensor, a hyperspectral sensor, and/or the like. In some embodiments, the one or more timing parameters 626 includes one or more of a specific time, a specific repeated time, a time range (e.g., a time window) from a beginning time to an end time, a time range periodically (e.g., daily, weekly, monthly, etc.), and/or the like.

According to certain embodiments, a monitoring request 630A includes data for one or more monitoring parameters including, for example, contextual data 632, one or more perception models 634, one or more fusion functions/activity metrics 636, one or more target criteria 638 (e.g., downlink criteria), and/or the like. In some embodiments, the contextual data 632 is stored in one or more data repositories. In certain embodiments, the contextual data 632 includes historical sensor data, model parameters, object parameters, and/or the like. In some embodiments, the one or more perception models 634 include one or more models for identifying and/or monitoring one or more target objects. In certain embodiments, the one or more perception models 634 include one or more computer-vision models for identifying objects in images and/or videos. In some embodiments, the one or more fusion functions 636 include one or more functions on sensor data and/or processed sensor data. In certain embodiments, the one or more activity metrics 636 include one or more movement metrics, movement pattern metrics, and/or the like. In some embodiment, the one or more target criteria 638 include one or more criteria associated with one or more target characteristics. In certain embodiments, the one or more target characteristics include a type of object, a size of object, a color of object, a shape of object, a feature of object, and/or the like.

According to some embodiments, the device constellation system 600 sends and combines one or more requests in the one or more queues 620, 630 to one or more selected edge devices 610. In certain embodiments, a collection request 620A in the collection request queue 620 is associated with a monitor request 630A in the monitor request queue 630 with one or more correlations 640 (e.g., pairing). In some embodiments, a collection request 620A is associated with one or more sensor parameters for a target object and a monitor request 630A is associated with one or more perception modes for the target object.

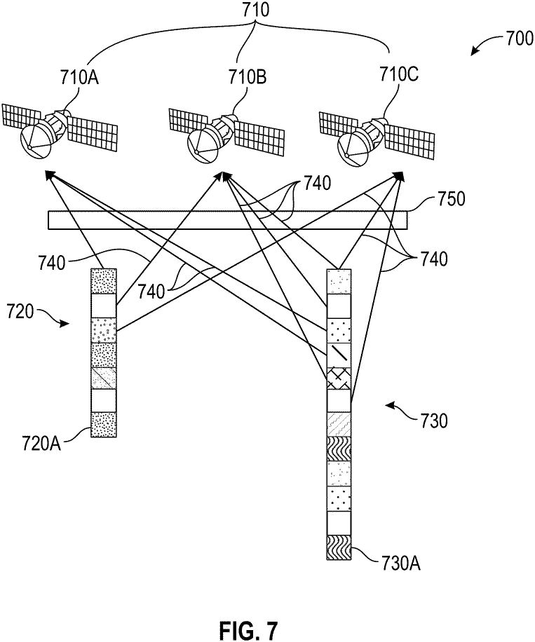

FIG. 7 is an illustrative device constellation system 700 (e.g., an AI meta-constellation system) according to certain embodiments of the present disclosure. FIG. 7 is merely an example. One of ordinary skill in the art would recognize many variations, alternatives, and modifications. In certain embodiments, the device constellation system 700 includes one or more edge devices 710, a collection request queue 720, a monitor request queue 730 (e.g., an algorithm request queue), and a constellation engine 750 (e.g., an optimization engine). In some embodiments, the device constellation system 700 provides a way for efficient use of edge devices (e.g., edge devices disposed on satellites).

According to certain embodiments, the one or more edge devices 710 includes a first edge device 710A (e.g., a computing device disposed on or integrated with a satellite, a satellite, a vessel, etc.), a second edge device 710B (e.g., a computing device disposed on or integrated with a satellite, a satellite, a vessel, etc.), and a third edge device 710C (e.g., a computing device disposed on or integrated with a satellite, a satellite, a vessel, etc.). In some embodiments, one or more of the edge devices 710 includes an AIP, for example, for receiving one or more requests and/or transmitting data. In certain embodiments, each edge device 710 includes an AIP, for example, for receiving one or more requests and/or transmitting data. In some embodiments, the device constellation system 700 includes two or more request queues storing one or more requests to the one or more edge devices 710. In certain embodiments, the queues are stored or accessible via one or more edge devices 710. In some embodiments, the collection request queue 720 includes one or more collection requests 720A for sensor data collection. In certain embodiments, the monitor request queue 730 includes one or more monitoring requests 730A for monitoring and processing requests.

According to some embodiments, a collection request 720A includes data for one or more collection parameters including, for example, one or more location and/or field-of-view parameters, one or more sensor parameters, one or more timing parameters (e.g., pass timing and/or revisit), and/or the like. In certain embodiments, the one or more location parameters include one or more of a geographic coordinate parameter, a latitude parameter, a longitudinal parameter, an altitude parameter, a geohash parameter, a GPS (global-positioning-system) parameter, and/or the like. In some embodiments, the one or more field-of-view parameters include one or more location parameters and one or more of an angle, an angle range, an area, and/or the like. In certain embodiments, the one or more sensor parameters include a type of sensor, a feature of sensor, a configuration of sensor, a sensing range, a sensing angle, a sensing time, and/or the like. In some examples, the sensor is an image sensor, and the sensor parameters include a zooming parameter, a resolution parameter, a frame rate parameter, a gain parameter, a binning parameter, an image format parameter, and/or the like. In certain examples, the sensor includes an acoustic sensor, a transducer, an ultrasonic sensor, an infrared sensor, a hyperspectral sensor, and/or the like. In some embodiments, the one or more timing parameters includes one or more of a specific time, a specific repeated time, a time range from a beginning time to an end time, a time range periodically (e.g., daily, weekly, monthly, etc.), and/or the like.

According to certain embodiments, a monitoring request 730A includes data for one or more monitoring parameters including, for example, contextual data, one or more perception models, one or more fusion functions/activity metrics, one or more target criteria (e.g., downlink criteria), and/or the like. In some embodiments, the contextual data is stored in one or more data repositories. In certain embodiments, the contextual data includes historical sensor data, model parameters, object parameters, and/or the like. In some embodiments, the one or more perception models include one or more models for identifying and/or monitoring one or more target objects. In certain embodiments, the one or more perception models include one or more computer-vision models for identifying objects in images and/or videos. In some embodiments, the one or more fusion functions include one or more functions on sensor data and/or processed sensor data. In certain embodiments, the one or more activity metrics include one or more movement metrics, movement pattern metrics, and/or the like. In some embodiment, the one or more target criteria include one or more criteria associated with one or more target characteristics. In certain embodiments, the one or more target characteristics include a type of object, a size of object, a color of object, a shape of object, a feature of object, and/or the like.

According to some embodiments, the device constellation system 700 sends and combines one or more requests 740 in the one or more queues 720, 730 to one or more selected edge devices 710. In certain embodiments, a collection request 720A in the collection request queue 720 is associated with a monitor request 730A in the monitor request queue 730 with one or more correlations. In some embodiments, a collection request 720A is associated with one or more sensor parameters for a target object and a monitor request 730A is associated with one or more perception modes for the target object.

According to certain embodiments, the constellation engine 750 generates or assigns one or more tasks 740 including one or more collection requests 720A from the collection request queue 720 and one or more monitor requests 730A from the monitor request queue 730. In some embodiments, the constellation engine 750 selects an edge device 710 for a task 740, and send the task 740 to the edge device 710. In certain embodiments, the constellation engine 750 selects the edge device 710 based at least in part upon the task 740. In some embodiments, the constellation engine 750 selects the edge device 710 based at least in part upon one or more sensor parameters in the task 740. In certain embodiments, the constellation engine 750 selects the edge device 710 based at least in part upon one or more location parameters and/or field-of-view parameters in the task 740. In some embodiments, the constellation engine 750 selects the edge device 710 based at least in part upon one or more timing parameters in the task 740. In certain embodiments, the constellation engine 750 selects the edge device 710 based at least in part upon one or more perception model parameters in the task 740. In certain embodiments, the constellation engine 750 selects the edge device 710 based at least in part upon one or more fusion functions in the task 740. In some embodiments, the constellation engine 750 selects the edge device 710 based at least in part upon one or more activity metrics in the task 740. In certain embodiments, the constellation engine 750 selects the edge device 710 based at least in part upon one or more target criteria in the task 740.

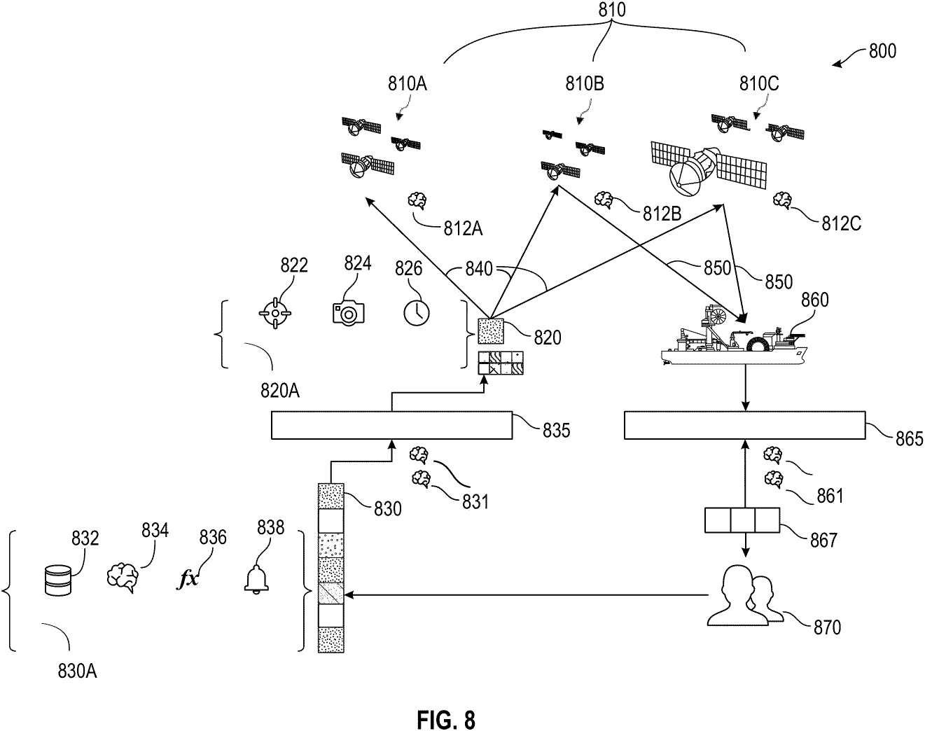

FIG. 8 is an illustrative device constellation system 800 (e.g., an AI meta-constellation system) according to certain embodiments of the present disclosure. FIG. 8 is merely an example. One of ordinary skill in the art would recognize many variations, alternatives, and modifications. In certain embodiments, the device constellation system 800 includes one or more edge device constellations 810, a collection request queue 820, a monitor request queue 830 (e.g., an algorithm request queue), a constellation engine 835, and an operational engine 865. In some embodiments, the device constellation system 800 provides a way for efficient use of edge devices (e.g., edge devices disposed on satellites).

According to certain embodiments, the one or more edge device constellations 810 includes a first edge device constellation 810A (e.g., one or more edge devices in a group, one or more computing devices disposed on or integrated with one or more satellites, etc.), a second edge device constellation 810B (e.g., one or more edge devices in a group, one or more computing devices disposed on or integrated with one or more satellites, etc.), and a third edge device 810C (e.g., one or more edge devices in a group, one or more computing devices disposed on or integrated with one or more satellites, etc.). In some embodiments, one or more of the edge device constellations 810 include an AIP, for example, for receiving one or more requests and/or transmitting data. In certain embodiments, each edge device constellation 810 includes a corresponding AIP 812A, 812B, 812C, for example, for receiving one or more requests and/or transmitting data. In some embodiments, the device constellation system 800 includes two or more request queues storing one or more requests to the one or more edge device constellations 810. In certain embodiments, the queues are stored or accessible via one or more edge device constellations 810. In some embodiments, the collection request queue 820 includes one or more collection requests 820A for sensor data collection. In certain embodiments, the monitor request queue 830 includes one or more monitoring requests 830A for monitoring and processing requests.

According to some embodiments, a collection request 820A includes data for one or more collection parameters including, for example, one or more location and/or field-of-view parameters 822, one or more sensor parameters 824, one or more timing parameters 826 (e.g., pass timing and/or revisit), and/or the like. In certain embodiments, the one or more location parameters 822 include one or more of a geographic coordinate parameter, a latitude parameter, a longitudinal parameter, an altitude parameter, a geohash parameter, a GPS (global-positioning-system) parameter, and/or the like. In some embodiments, the one or more field-of-view parameters include one or more location parameters and one or more of an angle, an angle range, an area, and/or the like. In certain embodiments, the one or more sensor parameters 824 include a type of sensor, a feature of sensor, a configuration of sensor, a sensing range, a sensing angle, a sensing time, and/or the like. In some examples, the sensor is an image sensor, and the sensor parameters include a zooming parameter, a resolution parameter, a frame rate parameter, a gain parameter, a binning parameter, an image format parameter, and/or the like. In certain examples, the sensor includes an acoustic sensor, a transducer, an ultrasonic sensor, an infrared sensor, a hyperspectral sensor, and/or the like. In some embodiments, the one or more timing parameters 826 include one or more of a specific time, a specific repeated time, a time range from a beginning time to an end time, a time range periodically (e.g., daily, weekly, monthly, etc.), and/or the like.

According to certain embodiments, a monitoring request 830A includes data for one or more monitoring parameters including, for example, contextual data 832, one or more perception models 834, one or more fusion functions/activity metrics 836, one or more target criteria 838 (e.g., downlink criteria), and/or the like. In some embodiments, the contextual data 832 is stored in one or more data repositories. In certain embodiments, the contextual data includes historical sensor data, model parameters, object parameters, and/or the like. In some embodiments, the one or more perception models 834 include one or more models for identifying and/or monitoring one or more target objects. In certain embodiments, the one or more perception models include one or more computer-vision models for identifying objects in images and/or videos. In some embodiments, the one or more fusion functions 836 include one or more functions on sensor data and/or processed sensor data. In certain embodiments, the one or more activity metrics 836 include one or more movement metrics, movement pattern metrics, and/or the like. In some embodiment, the one or more target criteria 838 include one or more criteria associated with one or more target characteristics. In certain embodiments, the one or more target characteristics 838 include a type of object, a size of object, a color of object, a shape of object, a feature of object, and/or the like.

According to certain embodiments, the constellation engine 835 receives one or more requests 830A in the monitoring queue 830, and decompose the request into one or more tasks 840, which combines one or more collection requests 820A from the collection request queue 820 and corresponding models. In some embodiments, the constellation engine 835 selects an edge device 810 for a task 840, and send the task 840 to the edge device and/or edge device constellation 810. In certain embodiments, the constellation engine 835 selects the edge device and/or edge device constellation 810 based at least in part upon the task 840. In some embodiments, the constellation engine 835 selects the edge device 810 based at least in part upon one or more sensor parameters in the task 840. In certain embodiments, the constellation engine 835 selects the edge device and/or edge device constellation 810 based at least in part upon one or more location parameters and/or field-of-view parameters in the task 840. In some embodiments, the constellation engine 835 selects the edge device and/or edge device constellation 810 based at least in part upon one or more timing parameters in the task 840. In certain embodiments, the constellation engine 835 selects the edge device and/or edge device constellation 810 based at least in part upon one or more perception model parameters in the task 840. In certain embodiments, the constellation engine 835 selects the edge device and/or edge device constellation 810 based at least in part upon one or more fusion functions in the task 840. In some embodiments, the constellation engine 835 selects the edge device and/or edge device constellation 810 based at least in part upon one or more activity metrics in the task 840. In certain embodiments, the constellation engine 835 selects the edge device and/or edge device constellation 810 based at least in part upon one or more target criteria in the task 840.

According to some embodiments, the device constellation system 800 is configured to select one or more edge devices (e.g., a plurality of edge devices) from one or more constellations (e.g., a plurality of constellations). In some examples, each of the one or more constellations is owned by and/or operated by an entity (e.g., a government organization, a company, an industry organization, etc.). As an example, two constellations are owned by and/or operated by two different entities. In certain examples, a meta-constellation is formed including one or more edge devices from one or more constellations owned by and/or operated by various entities. For example, the system 800 is configured to select multiple edge devices from a plurality of constellations, and each constellation of the plurality of constellations is owned by and/or operated by an entity (e.g., a government organization, a company, an industry organization, etc.). As an example, some selected multiple edge devices belong to a constellation owned by and/or operated by an entity, and other selected multiple edge devices belong to a different constellation owned by and/or operated by a different entity. In some examples, the system is configured to select one or more edge devices based on capability, eligibility, and/or availability of the corresponding edge device. For example, an edge device is a satellite that includes one or more sensors, where the one or more sensors are also referred to as orbit sensors. As an example, an edge device includes one or more sensors in the space. For example, an edge device is selected based on a viewing angle of an imaging sensor on the edge device. As an example, an edge device is selected based on its location in the water. In some examples, the system selects the edge device based upon one or more sensors and/or one or more models. For example, an edge device is selected to use a specific model to process data.

According to certain embodiments, the system 800 and/or the constellation engine is configured to assign the one or more tasks 840 to the one or more selected edge devices and/or edge device constellations 810. In some embodiments, the system 800 and/or the constellation engine is configured to assign the one or more tasks 840 to the one or more selected edge devices and/or edge device constellations 810 using one or more models 831 (e.g., an optimization model, a security model etc.). According to some embodiments, the one or more selected edge devices are configured to perform the one or more assigned tasks to generate data 850. In some examples, the one or more edge devices are configured to collect data during the performance of the one or more assigned tasks. In certain examples, the one or more edge devices are configured to process the collected data. In some examples, the edge device is configured to generate one or more insights by processing the data collected by one or more sensors on the edge device and/or data collected by one or more sensors on one or more other edge devices. In certain examples, the generated data 860 by the one or more selected edge devices includes the collected data, the processed data, the one or more insights, fused processed data (e.g., fused AI data), and/or a combination thereof. As an example, an edge device is assigned with a task of monitoring a space area for two weeks and is configured to filter the monitoring data (e.g., removing certain data). For example, an edge device is assigned with a task of detecting wildfire and is configured to process data collected from various sensors on the edge device and transmit an insight of whether wildfire is detected.

According to some embodiments, the system 800 and/or the constellation engine 835 is configured to request a source edge device to transmit data (e.g., collected data and/or processed data) to a destination edge device. In some examples, the destination edge device is configured to process data from the source edge device. In certain examples, the system is configured to move more complex processing to the one or more edge devices. In certain examples, two or more edge devices are configured to transmit data to a selected edge device for data processing.

According to certain embodiments, the system 800 and/or the operation engine 865 are configured to generate one or more actions 867 using one or more models 861 (e.g., a planning model, a scoring model, etc.). In some embodiments, the actions 867 include one or more actionable insights. In certain embodiments, the actions are provided to one or more users 870 (e.g., operational users).

According to some embodiments, FIG. 8 shows certain aspects of a device constellation system 800 (e.g., an AI meta-constellation system), for example, using deep sensing and/or associated with satellite marketplace (e.g., efficient satellite marketplace). In some examples, the device constellation system 800 combines one or more heterogenous satellite constellations and/or leveraging AI to give users actionable insights from one or more overhead sensors. In certain examples, the device constellation system compiles one or more user AI requests into one or more optimized collection requests across many specialized sensors and/or uploads one or more tailored AI models to edge devices (e.g., satellites). As an example, one or more AI insights are fused and returned to users for operational planning and/or execution via an operational engine 865.

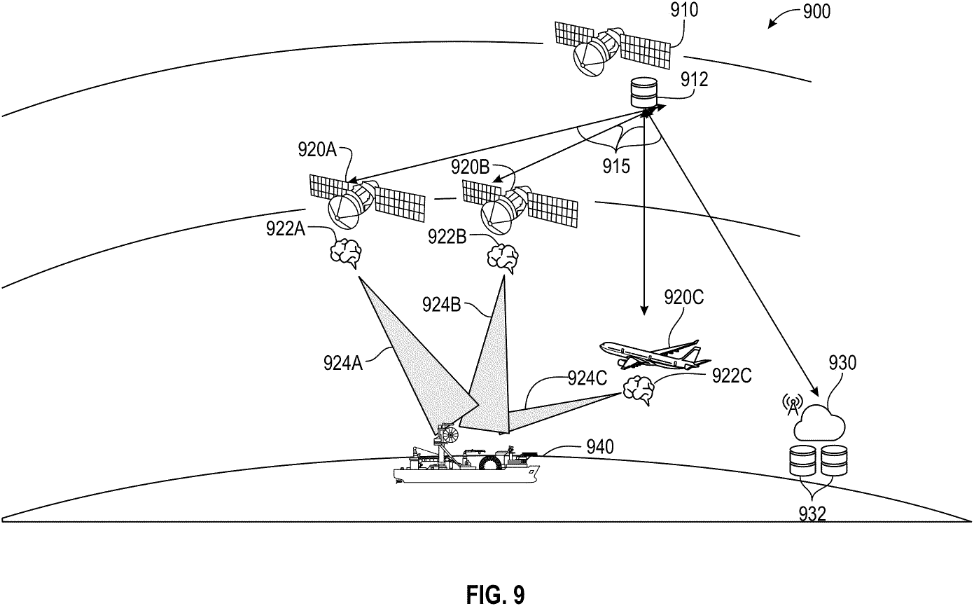

FIG. 9 is an illustrative device constellation environment 900 (e.g., an AI meta-constellation environment) according to certain embodiments of the present disclosure. FIG. 9 is merely an example. One of ordinary skill in the art would recognize many variations, alternatives, and modifications. In certain embodiments, the device constellation environment 900 includes a controlling edge device 910 with an associated data center 912, three edge devices 920A, 920B, 920C with associated respective AIP 922A, 922B, 922C, a controlling device 930 with one or more data repositories 932, and a target object 940.

According to certain embodiments, the controlling edge device 910 (e.g., a space data center) includes a constellation engine to receive a request (e.g., monitoring a water vessel for two weeks) from the controlling device 930 (e.g., a ground station, a cloud center). In some embodiments, the controlling edge device 910 is configured to decompose the request to one or more tasks 915 and assigns the one or more tasks 915 to respective edge devices 920A, 920B, 920C. In some embodiments, the controlling edge device 910 is configured to decompose the request to one or more tasks 915 and assign the one or more tasks 915 to respective edge devices 920A, 920B, 920C based on respective field-of-view 924A, 924B, 924C. In certain embodiments, the edge devices 920A, 920B, 920C are disposed on or integrated with various moving objects. In some examples, the first edge device 920A and/or the second edge device 920B include one or more computing devices disposed on or integrated with one or more satellites. In certain examples, the third edge device 920C includes one or more computing devices disposed on or integrated with one or more planes.

According to some embodiments, the controlling edge device 910 receives data (e.g., sensor data, processed sensor data, insights, etc.) from the edge devices 920A, 920B, 920C, for example, via the AIPs 922A, 922B, 922C, and generate data (e.g., insights, processed sensor data, fused target object data, fused AI data, etc.) based at least in part on the received data, for example, using one or more models. In certain embodiments, the controlling edge device 910 transmits the generated data to the controlling device 930, for example, to take additional actions based on the generated data. In some embodiments, FIG. 9 shows distributed AI operations, sensing, and/or cross-cueing related to device constellation systems (e.g., AI meta-constellation system).

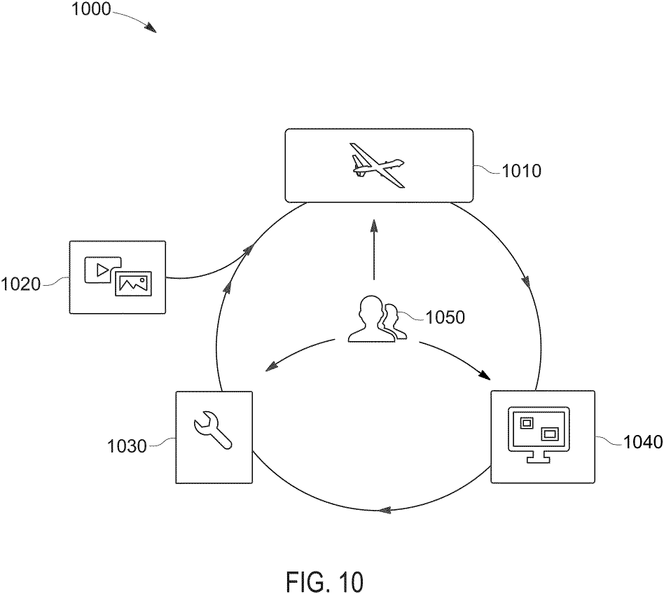

FIG. 10 is an illustrative AIP system 1000 (e.g., model orchestrators, task moderators), for example, used in a device constellation system, according to certain embodiments of the present disclosure. FIG. 10 is merely an example. One of ordinary skill in the art would recognize many variations, alternatives, and modifications. In some embodiments, the AIP system 1000 includes or interfaces with one or more AIPs 1010 running on edge devices, one or more data feed 1020 (e.g., video, imagery, etc.), a data management platform 1030, one or more decision-making applications 1040, and one or more feedback mechanism 1050. In some embodiments, the edge devices, by running the AIPs 1010, can perform real-time AI/ML on the edge. In certain embodiments, the one or more feedback mechanism 1050 is via software interface, user interface, and/or other input mechanism and communication mechanism. As used herein, in some embodiments, feedback includes one or more of commands, controls, results, and messages. In some embodiments, the AIP system 1000 can update, retrain, select, and/or delete one or more models based on the feedback. In certain embodiments, the decision-making applications 1040 can provide feedback to the AIPs 1010. In some embodiments, the decision-making applications 1040 can provide feedback to the data management platform 1030.

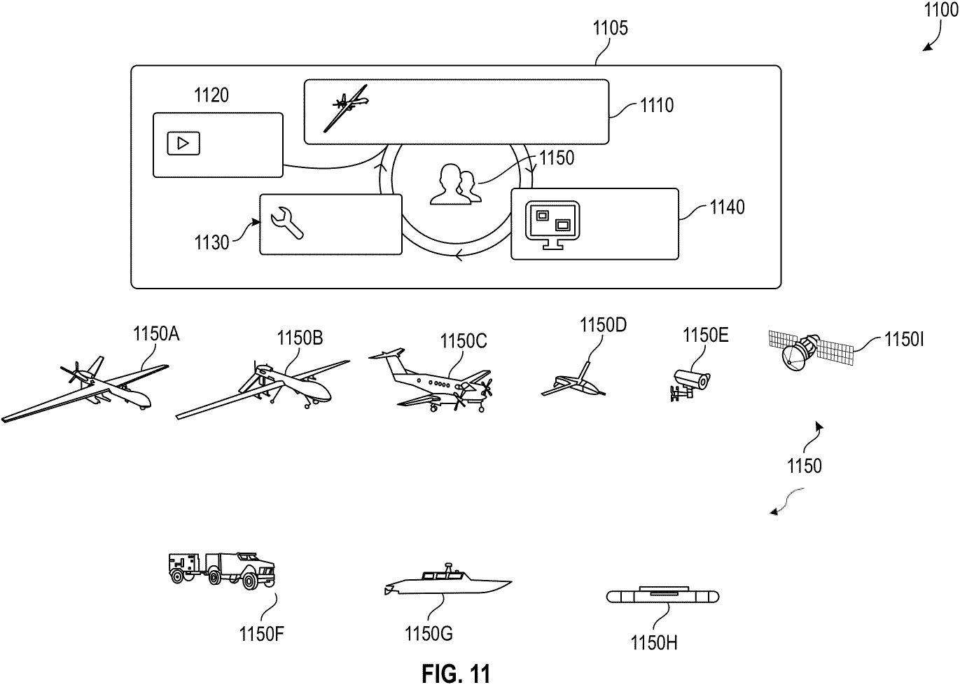

FIG. 11 is an illustrative constellation environment 1100 according to certain embodiments of the present disclosure. FIG. 11 is merely an example. One of ordinary skill in the art would recognize many variations, alternatives, and modifications. In some embodiments, the constellation environments include one or more AIPs 1105 and one or more edge devices 1150. In certain embodiments, the AIP 1115 includes or interfaces with one or more data feed 1120 (e.g., video, imagery, etc.), a data management platform 1130, one or more decision-making applications 1140, and one or more feedback mechanism 1150. In some embodiments, the constellation environment 1100 includes a plurality of edge devices 1150 including, for example, edge device 1150A, 1150B, 1150C, 1150D, 1150E, 1150F, 1150G, 1150H, 1150I. In certain embodiments, one or more of the edge devices 1150 have one or more respective AIP 1105.

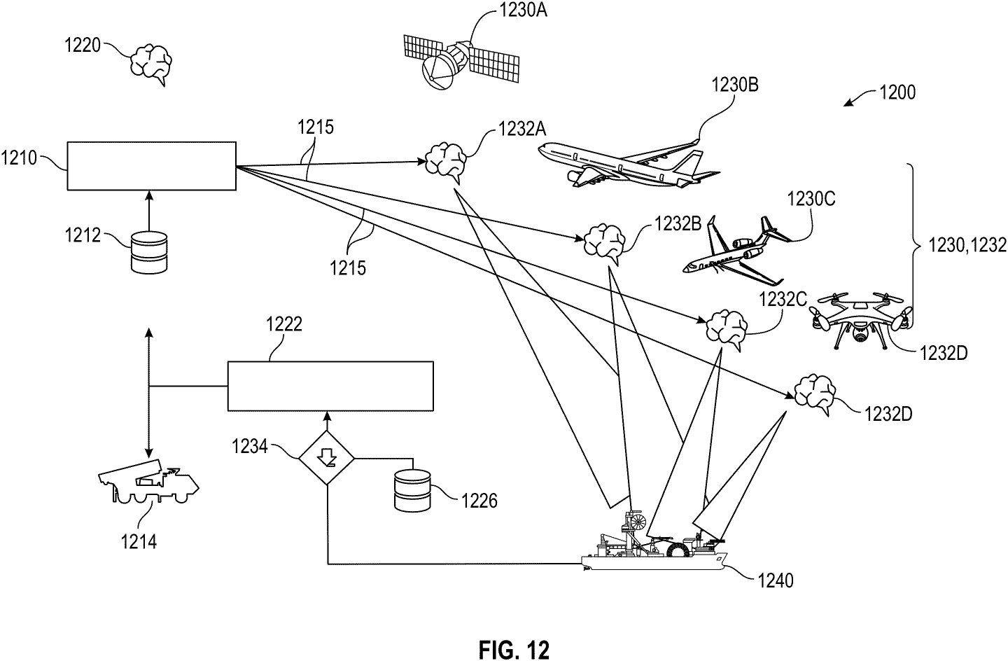

FIG. 12 shows an example device constellation system 1200 according to certain embodiments of the present disclosure. FIG. 12 is merely an example. One of ordinary skill in the art would recognize many variations, alternatives, and modifications. In some embodiments, the device constellation system 1200 (e.g., a meta-constellation system, an AI meta-constellation system) includes a development system 1210 (e.g., DMP) with associated data repository 1212 (e.g., storing historical sensor data, historical insight data, AIP configurations, AIP parameters, etc.) for generating and/or deploying one or more AIPs 1220, a model management system 1222 with associated deployment mechanism 1234 (e.g., a communication channel) and associated data repository 1226 (e.g., storing one or more models, one or more model parameters), one or more controllers 1214 to deploy AIPs 1220 with associated one or more models, one or more edge device 1230 with associated AIPs 1232 (e.g., AIP 1232A, AIP 1232B, AIP 1232C, AIP 1232D), and a target object 1240.

According to some embodiments, the device constellation system 1200 (e.g., a meta-constellation system, an AI meta-constellation system) develops and deploys (e.g., fields) one or more models (e.g., AI/ML (machine learning) models) to edge devices 1230 (e.g., customers with a system (e.g., a data use system)). In certain examples, the device constellation system 1200 integrates, models, and/or suggests one or more collection requests, for example, using the model management system 1222 (e.g., the data use system). In some examples, the device constellation system (e.g., meta-constellation system) analyzes in space with one or more AIPs 1232. In certain examples, the device constellation system 1200 fuses data across one or more edge devices 1230 (e.g., diverse space-based sensors) using the AIPs 1232. In some examples, the device constellation system (e.g., meta-constellation system, AI meta-constellation system) implements one or more sensor-to-actor (e.g., sensor-to-shooter) workflows using the edge devices 1230 (e.g., incorporated with the data use system) and the AIPs 1232. In certain embodiments, the device constellation system 1200 receives a request of monitoring the target object 1240 and assigns one or more respective tasks to monitor the target object 1240.

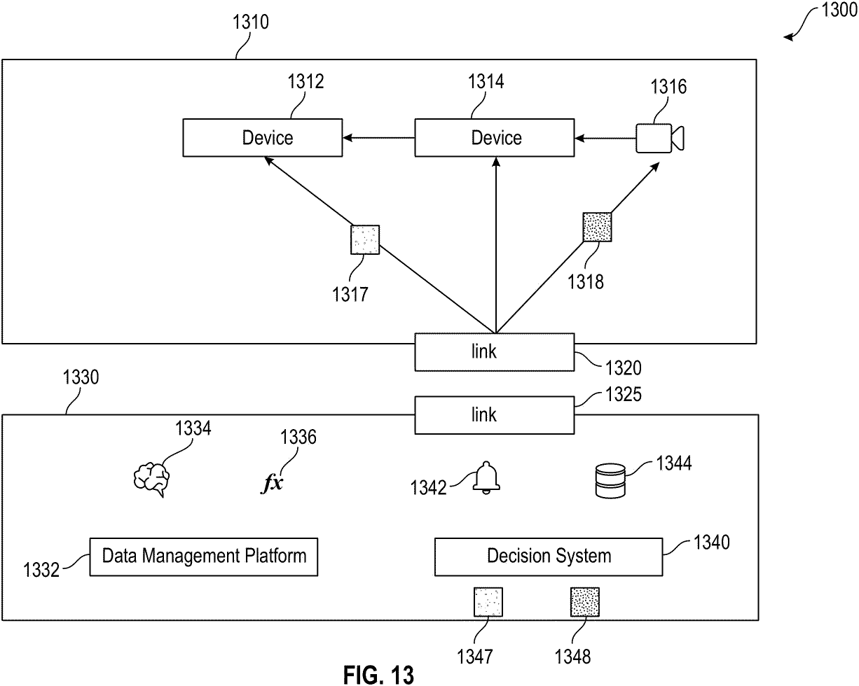

FIG. 13 is an example device constellation environment 1300 (e.g., an AI meta-constellation environment) according to certain embodiments of the present application. FIG. 13 is merely an example. One of ordinary skill in the art would recognize many variations, alternatives, and modifications. In some embodiments, the device constellation system 1300 includes an example request pipeline, for example, via links (e.g., uplinks, from controlling devices to edge devices) 1320 and 1325. In certain embodiments, the device constellation system environment 1300 conducts dynamic model (e.g., AI) deployment. In some embodiments, the device constellation environment 1300 includes one or more edge devices 1310 and one or more controlling devices 1330 (e.g., a ground station). In certain embodiments, the one or more edge devices 1310 include a sensor device 1316, a device 1314 (e.g., with associated AIP), and a device AIP 1312 (e.g., a passive device, with associated AIP). In some embodiments, the device 1312 receives a monitoring request 1317, for example, such that the associated edge device can run one or more models to meet the monitoring request. In certain embodiments, the sensor device 1316 includes one or more sensors and receives a collection request 1318, to start collecting data according to the collection request 1318.

According to some embodiments, the controlling devices 1330 (e.g., controlling edge devices) include a data management platform 1332 and a decision system 1340. In certain embodiments, the data management platform 1332 includes one or more models 1334, 1336 to be deployed via the links 1320, 1325 to the devices 1310. In certain embodiments, the decision system 1340 uses one or more models 1342 and contextual data stored in the data repository 1344 to generate the monitoring request 1317 and/or the collection request 1318.

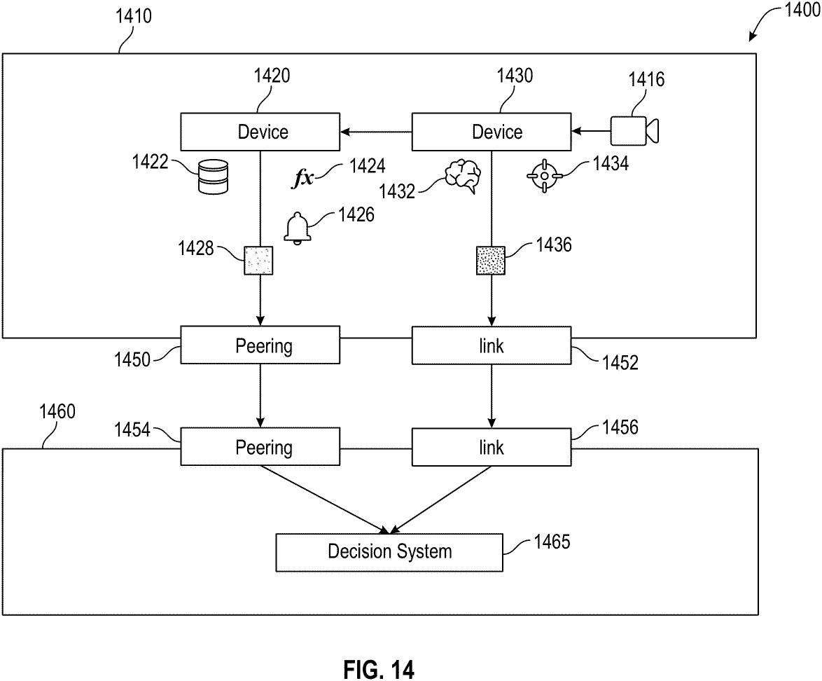

FIG. 14 is an example device constellation environment 1400 (e.g., an AI meta-constellation environment) according to certain embodiments of the present application. FIG. 14 is merely an example. One of ordinary skill in the art would recognize many variations, alternatives, and modifications. In some embodiments, the device constellation system 1400 includes an example inference pipeline, for example, via links (e.g., downlinks, from edge devices to controlling devices) 1452 and 1456. In certain embodiments, the inference pipeline includes passive path and active path. In some embodiments, the device constellation environment 1400 includes one or more edge devices 1410 and one or more controlling devices 1460. In certain embodiments, the edge devices 1410 include one or more edge devices 1416, 1420, 1430, each with or without an associated AIP. In some embodiments, the edge device 1416 includes one or more sensors to collect sensor data.

In certain embodiments, the edge device 1430 receives the sensor data or processed sensor data from the edge device 116, for example, via an AIP, and processes the received data with one or more models 1432, 1434 (e.g., perception models, georegistration models) to generate one or more collection results 1436. In some embodiments, the edge device 1430 sends data (e.g., collection results) to the edge device 1420 for further processing. In certain embodiments, the edge device 1420 applies one or more models 1424, 1426 (e.g., fusion functions, activity metric models, target criteria, etc.) to the data received from the edge device 1430 and data 1422 (e.g., contextual data). In certain embodiments, the edge device 1420 is configured to generate one or more monitoring results 1428 (e.g., insights).

According to some embodiments, the one or more edge devices 1410 transmit results to the one or more controlling devices 1460, which includes a decision system 1465. In certain embodiments, the collection results 1436 are transmitted to the decision system 1465. In some embodiments, the monitoring results are transmitted to the decision system 1465.

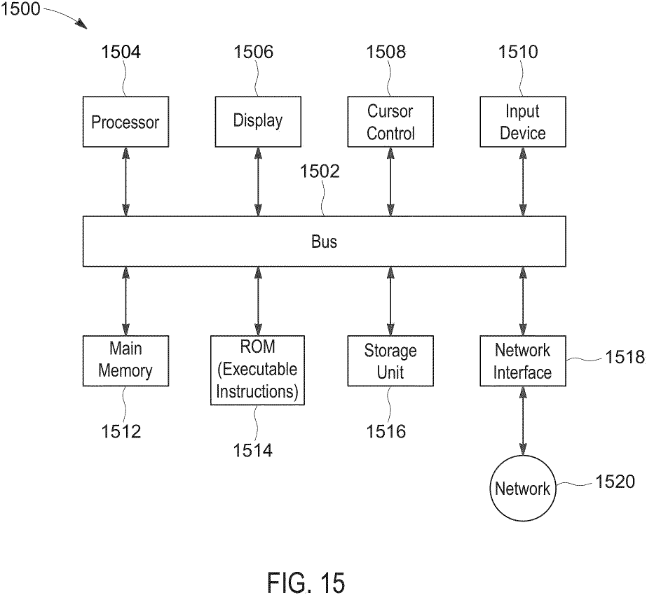

FIG. 15 is a simplified diagram showing a computing system for implementing a system for device constellation according to one embodiment of the present disclosure. This diagram is merely an example, which should not unduly limit the scope of the claims. One of ordinary skill in the art would recognize many variations, alternatives, and modifications. The computing system 1500 includes a bus 1502 or other communication mechanism for communicating information, a processor 1504, a display 1506, a cursor control component 1508, an input device 1510, a main memory 1512, a read only memory (ROM) 1514, a storage unit 1516, and a network interface 1518. In some embodiments, some or all processes (e.g., steps) of the method 100 and/or the method 200 are performed by the computing system 1500. In some examples, the bus 1502 is coupled to the processor 1504, the display 1506, the cursor control component 1508, the input device 1510, the main memory 1512, the read only memory (ROM) 1514, the storage unit 1516, and/or the network interface 1518. In certain examples, the network interface is coupled to a network 1520. For example, the processor 1504 includes one or more general purpose microprocessors. In some examples, the main memory 1512 (e.g., random access memory (RAM), cache and/or other dynamic storage devices) is configured to store information and instructions to be executed by the processor 1504. In certain examples, the main memory 1512 is configured to store temporary variables or other intermediate information during execution of instructions to be executed by processor 1504. For examples, the instructions, when stored in the storage unit 1516 accessible to processor 1504, render the computing system 1500 into a special-purpose machine that is customized to perform the operations specified in the instructions. In some examples, the ROM 1514 is configured to store static information and instructions for the processor 1504. In certain examples, the storage unit 1516 (e.g., a magnetic disk, optical disk, or flash drive) is configured to store information and instructions.

In some embodiments, the display 1506 (e.g., a cathode ray tube (CRT), an LCD display, or a touch screen) is configured to display information to a user of the computing system 1500. In some examples, the input device 1510 (e.g., alphanumeric and other keys) is configured to communicate information and commands to the processor 1504. For example, the cursor control 1508 (e.g., a mouse, a trackball, or cursor direction keys) is configured to communicate additional information and commands (e.g., to control cursor movements on the display 1506) to the processor 1504.

According to certain embodiments, a method for device constellation, the method comprising: receiving a request, the request including a plurality of request parameters; decomposing the request into one or more tasks; selecting one or more edge devices based at least in part on the plurality of request parameters; assigning the one or more tasks to the one or more selected edge devices to cause the one or more selected edge devices to perform the one or more tasks; and receiving one or more task results from the one or more selected edge devices; wherein the method is performed using one or more processors. For example, the method is implemented according to at least FIG. 1, FIG. 2, FIG. 8, and/or FIG. 12.

In some embodiments, the method further includes the step of fusing the one or more task results received from the one or more selected edge devices to generate a course of actions. In certain embodiments, the plurality of request parameters include one or more collection parameters, where the one or more collection parameters include at least one selected from a group consisting of a location parameter, a field-of-view parameter, a sensor parameter, and a timing parameter. In some embodiments, the selecting one or more edge devices comprises selecting the one or more edge devices based at least in part on at least one of the collection parameters. In certain embodiments, the plurality of request parameters include one or more monitoring parameters, where the one or more monitoring parameters include at least one selected from a group consisting of a model parameter, a fusion function parameter, and a target parameter. In some embodiments, the selecting one or more edge devices comprises selecting the one or more edge devices based at least in part on at least one of the monitoring parameters. In certain embodiments, the method further includes the steps of selecting one or more models based at least in part on the plurality of request parameters; and deploying the selected one or more models to at least one of the one or more selected edge devices.

In some embodiments, the method further includes the steps of receiving one or more additional requests; generating a plurality of request queues for the request and the one or more additional requests, the plurality of request queues including a first request queue for data collection and a second queue for data processing; decomposing the request and the one or more additional requests into a plurality of sub-requests; and storing the plurality of sub-requests into one of the plurality of request queues. In certain embodiments, at least one task of the one or more tasks is generated based on the plurality of sub-requests.

According to certain embodiments, a method for device constellation, the method includes the steps of: receiving a task assignment, the task assignment including one or more task parameters, the one or more task parameters including a set of collection parameters and a set of monitoring parameters; conducting a task according to the task assignment including the one or more task parameters to collect data; activating one or more models based at least in part on the monitoring parameters; generating a task result by applying the one or more models to the collected data; and transmitting the task result to a computing device; wherein the method is performed using one or more processors. For example, the method is implemented according to at least FIG. 1, FIG. 2, FIG. 8, and/or FIG. 12.

In some embodiments, the receiving a task assignment comprises receiving the task assignment via a task orchestrator, the task orchestrator including an indication of a model pipeline, the model pipeline including the one or more models. In certain embodiments, the activating one or more models includes the steps of receiving at least one model of the one or more models; and activating the at least one received model. In some embodiments, the transmitting the task result to a computing device comprises transmitting the task result via the task orchestrator.

According to certain embodiments, a system for device constellation, the system comprising: one or more memories comprising instructions stored thereon; and one or more processors configured to execute the instructions and perform operations comprising: receiving a request, the request including a plurality of request parameters; decomposing the request into one or more tasks; selecting one or more edge devices based at least in part on the plurality of request parameters; assigning the one or more tasks to the one or more selected edge devices to cause the one or more selected edge devices to perform the one or more tasks; and receiving one or more task results from the one or more selected edge devices. For example, the system is implemented according to at least FIG. 1, FIG. 2, FIG. 8, and/or FIG. 12.

In some embodiments, the operations further include the steps of fusing the one or more task results received from the one or more selected edge devices to generate a course of actions. In certain embodiments, the plurality of request parameters include one or more collection parameters, where the one or more collection parameters include at least one selected from a group consisting of a location parameter, a field-of-view parameter, a sensor parameter, and a timing parameter. In some embodiments, the selecting one or more edge devices comprises selecting the one or more edge devices based at least in part on at least one of the collection parameters.

In certain embodiments, the plurality of request parameters include one or more monitoring parameters, where the one or more monitoring parameters include at least one selected from a group consisting of a model parameter, a fusion function parameter, and a target parameter. In some embodiments, the selecting one or more edge devices comprises selecting the one or more edge devices based at least in part on at least one of the monitoring parameters. In certain embodiments, the operations further include the steps of selecting one or more models based at least in part on the plurality of request parameters; and deploying the selected one or more models to at least one of the one or more selected edge devices.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems’ and methods’ data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer’s hard drive, DVD, etc.) that contain instructions (e.g., software) for use in execution by a processor to perform the methods’ operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A method for device constellation, the method comprising:
receiving a request, the request including a plurality of request parameters;
decomposing the request into one or more tasks;
selecting one or more edge devices based at least in part on the plurality of request parameters;
assigning the one or more tasks to the one or more selected edge devices to cause the one or more selected edge devices to perform the one or more tasks; and
receiving one or more task results from the one or more selected edge devices;
wherein the method is performed using one or more processors.

2. The method of claim 1, further comprising:
fusing the one or more task results received from the one or more selected edge devices to generate a course of actions.

3. The method of claim 1, wherein the plurality of request parameters include one or more collection parameters, wherein the one or more collection parameters include at least one selected from a group consisting of a location parameter, a field-of-view parameter, a sensor parameter, and a timing parameter.

4. The method of claim 3, wherein the selecting one or more edge devices comprises selecting the one or more edge devices based at least in part on at least one of the collection parameters.

5. The method of claim 1, wherein the plurality of request parameters include one or more monitoring parameters, wherein the one or more monitoring parameters include at least one selected from a group consisting of a model parameter, a fusion function parameter, and a target parameter.

6. The method of claim 5, wherein the selecting one or more edge devices comprises selecting the one or more edge devices based at least in part on at least one of the monitoring parameters.

7. The method of claim 6, further comprising:
selecting one or more models based at least in part on the plurality of request parameters; and
deploying the selected one or more models to at least one of the one or more selected edge devices.

8. The method of claim 1, further comprising:
receiving one or more additional requests;
generating a plurality of request queues for the request and the one or more additional requests, the plurality of request queues including a first request queue for data collection and a second queue for data processing;
decomposing the request and the one or more additional requests into a plurality of sub-requests; and
storing the plurality of sub-requests into one of the plurality of request queues.

9. The method of claim 8, wherein at least one task of the one or more tasks is generated based on the plurality of sub-requests.

10. A method for device constellation, the method comprising:
receiving a task assignment, the task assignment including one or more task parameters, the one or more task parameters including a set of collection parameters and a set of monitoring parameters;
conducting a task according to the task assignment including the one or more task parameters to collect data;
activating one or more models based at least in part on the monitoring parameters;
generating a task result by applying the one or more models to the collected data; and
transmitting the task result to a computing device;
wherein the method is performed using one or more processors.

11. The method of claim 10, wherein the receiving a task assignment comprises receiving the task assignment via a task orchestrator, the task orchestrator including an indication of a model pipeline, the model pipeline including the one or more models.

12. The method of claim 11, wherein the activating one or more models comprises:
receiving at least one model of the one or more models; and
activating the at least one received model.

13. The method of claim 11, wherein the transmitting the task result to a computing device comprises transmitting the task result via the task orchestrator.

14. A system for device constellation, the system comprising:
one or more memories comprising instructions stored thereon; and
one or more processors configured to execute the instructions and perform operations comprising:
receiving a request, the request including a plurality of request parameters;
decomposing the request into one or more tasks;
selecting one or more edge devices based at least in part on the plurality of request parameters;
assigning the one or more tasks to the one or more selected edge devices to cause the one or more selected edge devices to perform the one or more tasks; and
receiving one or more task results from the one or more selected edge devices.

15. The system of claim 14, wherein the operations further comprise:
fusing the one or more task results received from the one or more selected edge devices to generate a course of actions.

16. The system of claim 14, wherein the plurality of request parameters include one or more collection parameters, wherein the one or more collection parameters include at least one selected from a group consisting of a location parameter, a field-of-view parameter, a sensor parameter, and a timing parameter.

17. The system of claim 16, wherein the selecting one or more edge devices comprises selecting the one or more edge devices based at least in part on at least one of the collection parameters.

18. The system of claim 14, wherein the plurality of request parameters include one or more monitoring parameters, wherein the one or more monitoring parameters include at least one selected from a group consisting of a model parameter, a fusion function parameter, and a target parameter.

19. The method of claim 18, wherein the selecting one or more edge devices comprises selecting the one or more edge devices based at least in part on at least one of the monitoring parameters.

20. The system of claim 19, wherein the operations further comprise:
selecting one or more models based at least in part on the plurality of request parameters; and
deploying the selected one or more models to at least one of the one or more selected edge devices.
